(19) United States
(12) Patent Application Publication
(10) Pub. No.: US 2009/0302849 A1
(43) Pub. Date: Dec. 10, 2009

(54) ELECTROMAGNETIC EXPLORATION

(75) Inventors: IVAN VASCONCELOS, Edinburgh (GB); ROBERT I. BLOOR, Missouri City, TX (US)

Correspondence Address: WONG, CABELLO, LUTSCH, RUTHERFORD & BRUCCULERI,;L.L.P., 20333 SH 249 6th Floor, HOUSTON, TX, 77070, US

(73) Assignee: ION GEOPHYSICAL CORPORATION, HOUSTON, TX (US)

(21) Appl. No.: 12/475,239

(22) Filed: May 29, 2009

Related U.S. Application Data
(60) Provisional application No. 61/057,606, filed on May 30, 2008.

(51) Int. Cl. G01V 3/00

(52) U.S. Cl. 324/334

(57) ABSTRACT

A system and method include receiving electromagnetic energy emanating from a target using a plurality of receivers, and generating a pseudo-source based at least in part on a location of one or more of the plurality of receivers and the received electromagnetic information.

### CROSS REFERENCE TO RELATED APPLICATIONS

This application claims priority to Provisional U.S. Patent Application Ser. No. 61/057,606, filed May 30, 2008, which is hereby incorporated by reference in its entirety.

### TECHNICAL FIELD

The present disclosure generally relates to electromagnetic surveying and in particular to methods and apparatus for acquiring and processing geophysical information.

### BACKGROUND

In the oil and gas exploration industry, geophysical tools and techniques are commonly employed in order to identify a subterranean structure having potential hydrocarbon deposits. One such technique utilizes electromagnetic energy in a process known as electromagnetic prospecting.

Electromagnetic prospecting is a geophysical method employing the generation of electromagnetic fields at the Earth's surface. The electromagnetic fields may have a wave character, a diffusive character, or a combination of the two. When the fields penetrate the Earth and impinge on a conducting formation or orebody, they induce currents in the conductors, which are the source of new fields radiated from the conductors and detected by instruments at the surface.

### SUMMARY

The following presents a general summary of several aspects of the disclosure in order to provide a basic understanding of at least some aspects of the disclosure. This summary is not an extensive overview of the disclosure. It is not intended to identify key or critical elements of the disclosure or to delineate the scope of the claims. The following summary merely presents some concepts of the disclosure in a general form as a prelude to the more detailed description that follows.

Disclosed is a method for gathering geophysical information that includes receiving electromagnetic energy emanating from a subsurface target using a plurality of receivers, and generating a pseudo-source based at least in part on a location of one or more of the plurality of receivers and the received electromagnetic information.

### BRIEF DESCRIPTION OF THE DRAWINGS

For a detailed understanding of the present disclosure, reference should be made to the following detailed description of the several non-limiting embodiments, taken in conjunction with the accompanying drawings, in which like elements have been given like numerals and wherein:

FIG. 1 is a non-limiting example of a geophysical information gathering system;

FIG. 2 illustrates a non-limiting example of sensor nodes that may be used according to several embodiments of the disclosure;

FIG. 3 illustrates several non-limiting examples of an electromagnetic radiator that may be used in a system according to FIG. 1;

FIGS. 4, 5 and 6 illustrate electric field diagrams associated with a cube-like electromagnetic source;

FIGS. 7, 8 and 9 illustrate magnetic field diagrams associated with a cube-like electromagnetic source;

FIGS. 10, 11 and 12 illustrate several non-limiting multi-component source configurations according to several embodiments of the disclosure;

FIG. 13 illustrates a non-limiting example of a geophysical information processing system that may be used in accordance with the several embodiments;

FIG. 14 shows a non-limiting method for geophysical information processing; and

FIG. 15 shows another non-limiting method for geophysical information processing.

### DESCRIPTION OF EXEMPLARY EMBODIMENTS

Portions of the present disclosure, detailed description and claims may be presented in terms of logic, software or software implemented aspects typically encoded on a variety of media including, but not limited to, computer-readable media, machine-readable media, program storage media or computer program product. Such media may be handled, read, sensed and/or interpreted by an information processing device. Those skilled in the art will appreciate that such media may take various forms such as cards, tapes, magnetic disks (e.g., floppy disk or hard drive) and optical disks (e.g., compact disk read only memory (“CD-ROM”) or digital versatile (or video) disc (“DVD”)). Any embodiment disclosed herein is for illustration only and not by way of limiting the scope of the disclosure or claims.

The present disclosure uses terms, the meaning of which terms will aid in providing an understanding of the discussion herein. For example, the term information processing device mentioned above as used herein means any device that transmits, receives, manipulates, converts, calculates, modulates, transposes, carries, stores or otherwise utilizes information. In several non-limiting aspects of the disclosure, an information processing device includes a computer that executes programmed instructions for performing various methods.

Geophysical information as used herein means information relating to the location, shape, extent, depth, content, type, properties of and/or number of geologic bodies. Geophysical information includes, but is not necessarily limited to marine and land electromagnetic information. Electromagnetic information as used herein includes, but are not limited to, one or more or any combination of analog signals, digital signals, recorded data, data structures, database information, parameters relating to surface geology, source type, source location, receiver location, receiver type, time of source activation, source duration, source frequency, energy amplitude, energy phase, energy frequency, wave acceleration, wave velocity and/or wave direction, field intensity and/or field direction.

Geophysical information may be used for many purposes. In some cases, geophysical information may be used to generate an image of subterranean structures. Imaging, as used herein includes any representation of a subsurface structure including, but not limited to, graphical representations, mathematical or numerical representation, strip charts or any other process output representative of the subsurface structure.

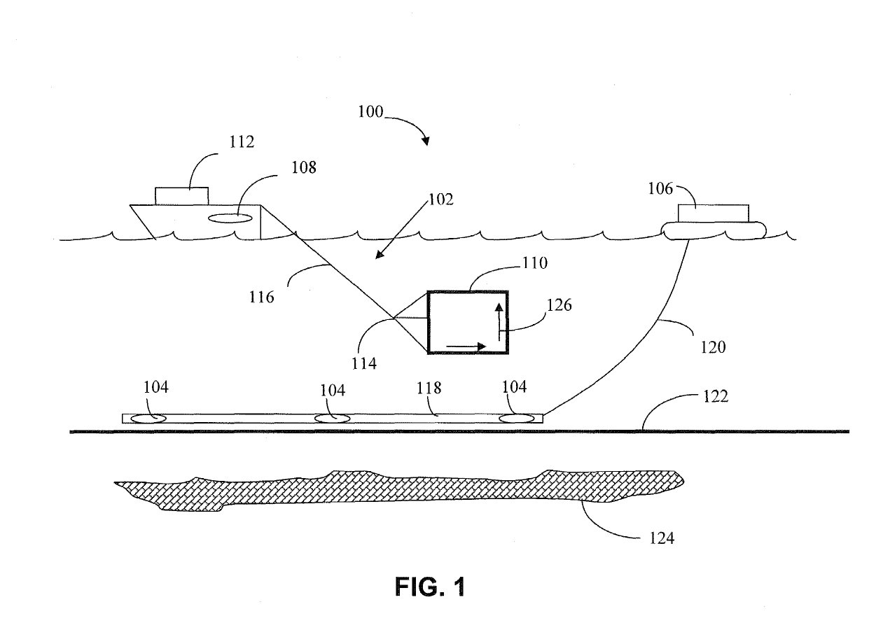

FIG. 1 is a non-limiting example of a geophysical information gathering system 100. The system 100 may include any number of subsystems and components. The system 100 in this example includes an energy source 102. One or more sensors 104 are positioned in a survey area, and the sensors are coupled to a recorder 106. In one or more embodiments, the sensors 104 may be incorporated into an ocean-bottom cable 118 and the ocean-bottom cable may be connected to the recorder 106 via a suitable communication interface 120, such as a riser cable. In this example, the ocean-bottom cable is shown position in or on the seabed 122 where signals emanating from a target 124, which may include subterranean strata, a hydrocarbon-bearing reservoir or other geologic structure, may be detected by the several sensors 104. The non-limiting system 100 illustrates a marine environment and a radiator 110 being towed by a vessel 112. In other embodiments, a radiator may be towed in an airborne configuration over a body of water or over land without departing from the scope of the disclosure. In other embodiments, the electromagnetic source 102 may be deployed in a stationary or semi-stationary fashion on land or in a marine environment without departing from the scope of the disclosure. Regardless of the environment selected for the geophysical information gathering system 100, the information gathered may be processed according to several methods disclosed herein by using a suitable geophysical information processing system.

The sensors 104 may include any number of sensors useful in gathering geophysical information. In one or more embodiments, the sensors may include electromagnetic sensors such as antennas, electrodes, magnetometers or any combination thereof. In one or more embodiments, the sensors may include pressure sensors such as microphones, hydrophones and their combinations. In one or more embodiments, the sensors 104 may include particle motion sensors such as geophones, accelerometers and combinations thereof. In one or more embodiments, the sensors may include combinations of electromagnetic sensors, pressure sensors and particle motion sensors. The non-limiting example system of FIG. 1 illustrates a sensor arrangement using an ocean-bottom cable 118. In one or more embodiments, sensor stations may be placed on the seabed and received signals may be recorded at each sensor station.

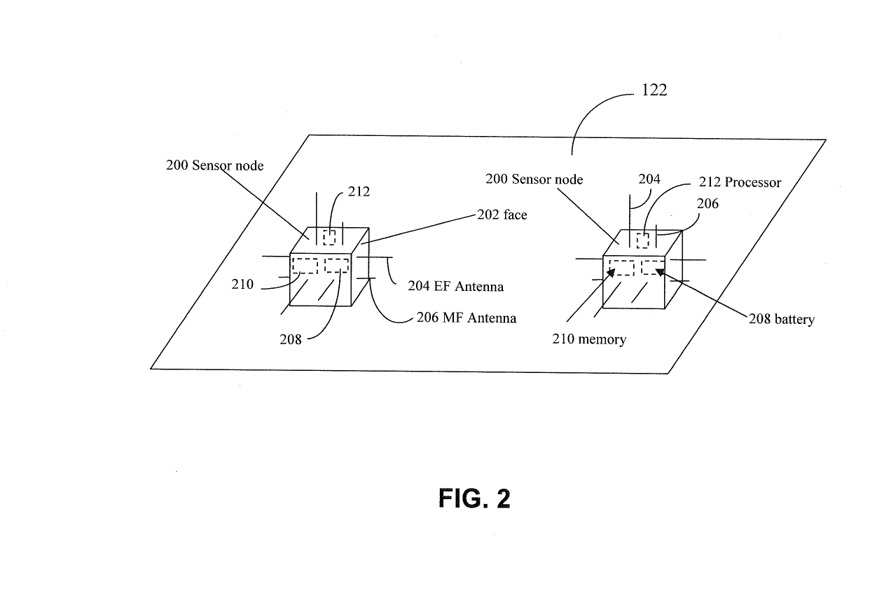

FIG. 2 illustrates a non-limiting example of sensor nodes that may be used according to several embodiments of the disclosure. Shown are two sensor nodes 200 that may be substantially similar to one another. Each sensor node 200 is placed on the seabed 122, although land deployment is within the scope of the disclosure. A sensor node 200 according to one or more embodiments may include several faces 202. Each face may include an electric field sensor 204 and a magnetic field sensor 206. The sensors 204, 206 may be in the form of dipole antennas. In the example embodiment of FIG. 2, the nodes 200 are stand-alone, and do not use a cable 118 or surface recorder 106 as in the example system described above and shown FIG. 1. The nodes 200, however, may be modified for connecting to a cable and remote recorder without departing from the scope of this disclosure. Each node 200 may include one or more batteries 208 for providing power to the node 200. In one or more embodiments, the node 200 may include a memory 210 for storing information received at the node 200. A processor 212 may be included for controlling the node 200 and for processing information received by the node 200.

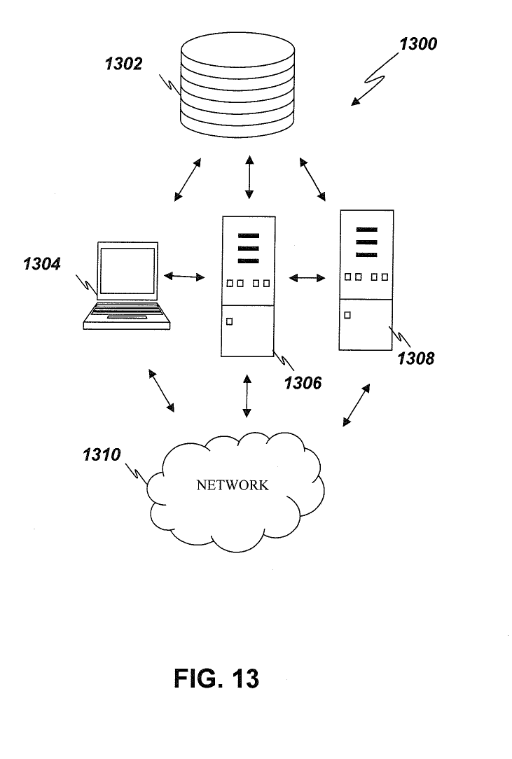

Referring still to FIGS. 1 and 2, the sensors 104, 204, 206 may generate analog, digital or a combination of analog and digital signals for recording. The recorder 106 or station 200 may be any suitable recorder for receiving and storing the signals generated by the sensors 104, 204, 206. The recorder 106 or station 200 may include any number of geophysical information processing, storing and transmitting components. More detail of at least some components suitable for portions of the recorder 106 or station will be provided later with reference to FIG. 13.

The energy source 102 may include any one or combination of several source types. In this example, the energy source includes an energy generator 108 that produces electromagnetic energy useful in a process known as controlled source electromagnetics (CSEM). The energy generator 108 is coupled to a multi-dimensional electromagnetic energy radiator 110. The term radiator is used herein to mean any device, structure, mechanism, combination thereof, and subcomponents thereof suitable for radiating energy. In the example system 100 of FIG. 1, the generator 108 is shown disposed on a marine vessel 112. The generator 108 may be configured for generating alternating current (AC) or direct current (DC) in the radiator 110. When alternating current is used, the frequency used may be a varying frequency useful in frequency-modulated CSEM. In one or more embodiments, the amplitude of the current 126 flowing in the radiator 110 may be modulated. The radiator 110 is coupled to the vessel 112 via a suitable coupling 114 and a tow cable 116 so that the vessel 112 may convey the radiator 110 through the desired media. In this example, the radiator 110 is conveyed through water at a predefined depth. In one or more embodiments, the tow cable 116 and the coupling 114 include a large gauge conductor for carrying electrical current to the radiator 110. The radiator 110 may be a substantially straight or curved structure such as a cable, or the radiator 110 may include a multi-dimensional structure.

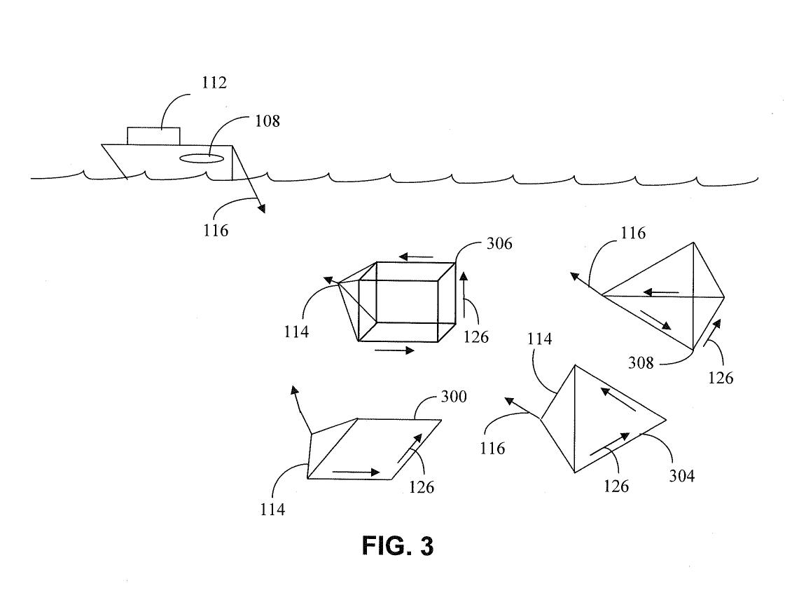

FIG. 3 illustrates several non-limiting examples suitable for multi-dimensional radiator structures. A multi-dimensional radiator structure may include a two-dimensional polygonal structure such as a square, a triangle, or the like. Orientation of the radiator structure may vary during operation, and the methods to be described below may be used without precise knowledge of the radiator structure orientation. For example, the radiator structure may be oriented during operation vertically as illustrated in FIG. 1 or horizontally as illustrated in FIG. 3 at 300 and 304, or the radiator structure may be in any other orientation. The radiator structures shown in FIG. 3 are but a few examples that do not limit the disclosure to any particular shape. The non-limiting radiator structures shown here include a square two-dimensional radiator structure 300 and a triangular two dimensional radiator structure 304. Each of these two-dimensional radiator structures may be coupled to the vessel 112 via the coupling 114 and tow cable 116 as described above and shown in FIG. 1.

Other suitable radiator structures may include three-dimensional structures. For example, a cube structure 306 or a tetrahedron radiator structure 308 may be coupled to the vessel 112. In some cases, the towing configuration may be such that the tow cable 116 may be connected directly to a radiator structure as shown with the tetrahedron radiator structure 306.

While substantially straight-ribbed radiator structures are shown, curved structures and radiator structures having a combination of curved and straight-ribbed structures may be used. In one or more embodiments, curved portions of a radiator structure may include at least a portion of curved shapes. Non-limiting examples include a curved structure such as a circle, oval or the like. Each branch of the multi-dimensional radiator structure 300, 304, 306, and 308 may carry electrical current 126 in a selected circuitous direction. Those skilled in the art with the benefit of the present disclosure will appreciate that the several circuitous current paths will generate both electrical fields and magnetic fields, each having multiple respective components depending on the particular current path selected.

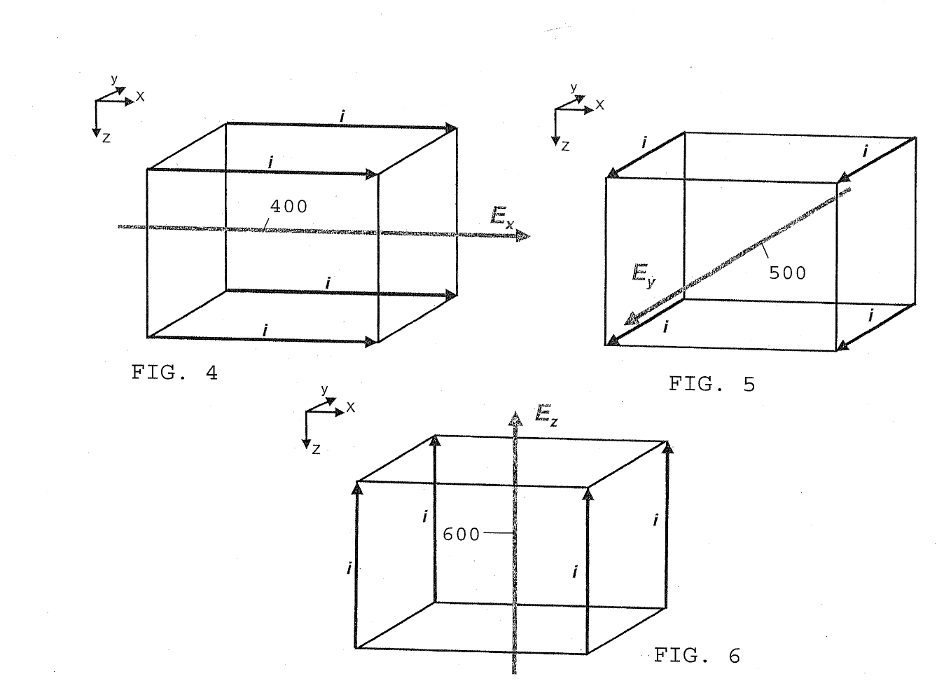

FIGS. 4, 5 and 6 illustrate electric field diagrams associated with a cube-like electromagnetic dipole-tensor source as an example of multi-component electric and magnetic field generating according to several embodiments of the disclosure. Those skilled in the art with the benefit of the present disclosure will be able to extend the teaching of the cube-like source to the several other source geometries disclosed herein and to others.

FIG. 4 illustrates that an electric field Ex as indicated at 400 may be generated in the x-direction by flowing an electrical current i in conductors parallel to the x-direction and in the direction of Ex. FIG. 5 illustrates that an electric field Ey as indicated at 500 may be generated in the y-direction by flowing an electrical current i in conductors parallel to the y-direction and in the direction of Ey. FIG. 6 illustrates that an electric field Ez as indicated at 600 may be generated in the z-direction by flowing an electrical current i in conductors parallel to the z-direction and in the direction of Ez.

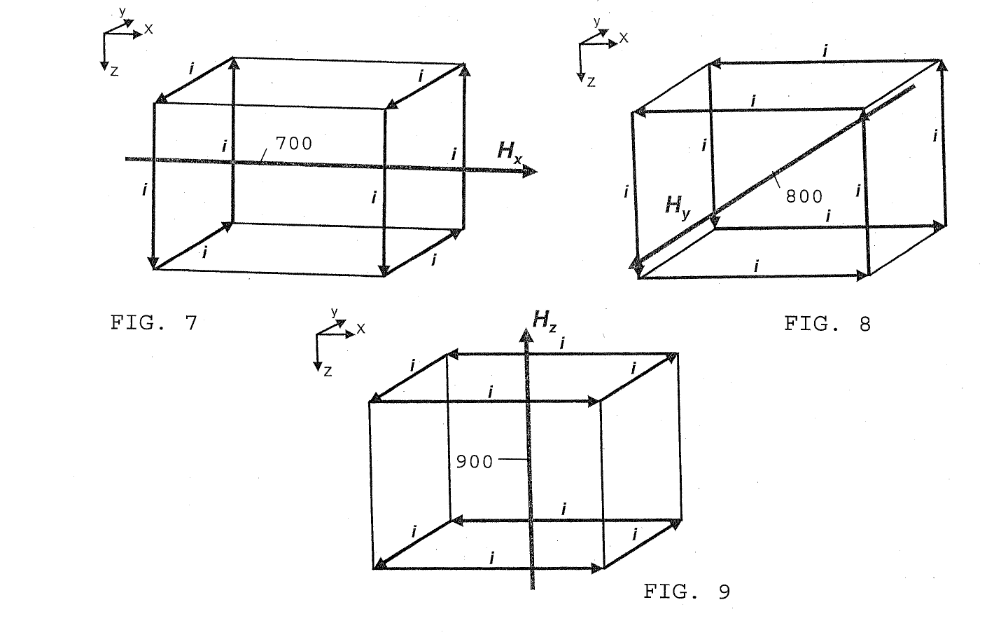

FIGS. 7, 8 and 9 illustrate magnetic field diagrams associated with a cube-like electromagnetic dipole-tensor source. FIG. 7 illustrates that a magnetic field Hx as indicated at 700 may be generated in the x-direction by flowing an electrical current i in conductors lying perpendicular to the x-direction. The direction of Hx (or —Hx) may be determined by the well-known right-hand rule and the direction of current flow. Hx is generally a vector perpendicular to a plane associated with the conductor carrying the current i. Similarly, FIGS. 8 and 9 illustrate respective magnetic fields Hy 800 and Hz 900 for a cube-like structure.

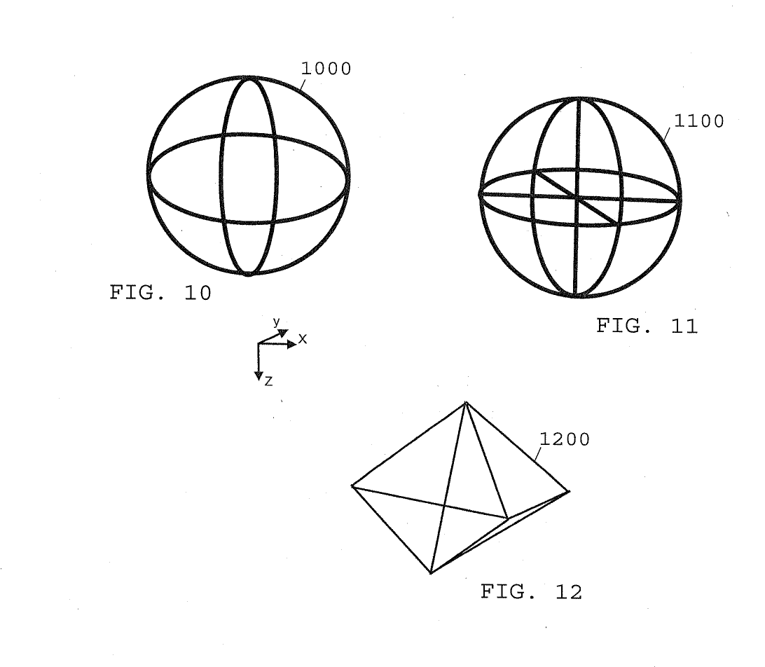

FIGS. 10, 11 and 12 illustrate several non-limiting multi-component source configurations according to several embodiments of the disclosure. FIG. 10 illustrates a source structure 1000 that may be used to generate a three-component magnetic field. FIG. 11 illustrates a non-limiting example of a source structure 1100 that may be used to generate a three-component electric field. FIG. 12 illustrates a non-limiting example of a source structure 1200 that may be used to generate three-component magnetic fields and three-component electric fields. In one or more embodiments, the angle between any two branches of the structure 1200 is about 60°.

FIG. 13 illustrates a non-limiting example of a geophysical information processing system 1300 that may be used in accordance with the several embodiments. Geophysical information may be gathered from a system 100 as described above and shown in FIG. 1. In several non-limiting examples, the system 100 may include one or more or any combination of the components shown in FIG. 13. In one example, the system 1300 may include one or more processing devices such as a computer and a storage device 1302. The computer may be selected from any number of useful computer devices, examples of which include, but are not limited to, laptop computers 1304, desk top computers 1306, mainframes 1308 and the like. While a laptop-type is shown, the processing unit need not include user interface devices. However, when appropriate, the computer 1304 may include a display, keyboard and or other input/output devices such as printers/plotters, a mouse, touch screen, audio output and input or any other suitable user interface.

The computer 1304 may be in communication with the storage device 1302 via any known interface and an interface for entering information into the computer 1304, 1306, 1308 may be any acceptable interface. For example, the interface may include the use of a network interface 1310.

The storage device 1302 according to one or more embodiments may be any useful storage device having a computer-readable media. Instructions for carrying out methods that will be described later may be stored on computer-readable media in the computer 1304, 1306, 1308 or may be stored on an external storage device 1302.

Operation of the exemplary geophysical information gathering system 100 will now be explained with reference to FIGS. 1-13. An electromagnetic field signal may be emanated from the energy source 102 and propagate toward the seabed 122. The electromagnetic field signal may include electric field having one or more electric field components, a magnetic field having one or more magnetic field components or a combination of electric and magnetic fields. The electromagnetic field signal travels within the earth, and may interact with the subterranean target 124. Conductive targets such as strata, or strata having conductive fluids, will respond to the electromagnetic field signal to generate a response field that travels generally upward toward the seabed and sensors 104. The sensors detect the down-going and up-going fields, and the detected fields are transmitted to the recorder 106 via conductors in the communication interface 120.

The recorded signals may be processed on location or may be transmitted to a processing facility having a geophysical information processing system 1300 as described above and shown in FIG. 13. The several processing components need not be co-located and may communicate via the network 1310. The methods described herein are based on novel interferometry concepts that warrant discussion here.

Introduction—Representation theorems in perturbed media

Let the general frequency-domain matrix-vector differential equation, \hat{Ā}{circumflex over (()}î\hat{ω}{circumflex over (Ā(iω +̅v·∇)û+\hat{B}û+\hat{D}ᵣû=ŝ, which describes different physical phenomena such as field propagation (e.g., electromagnetic), diffusive and advective transport. û=û(r,ω) is the vector that contains field quantities as a function of space r and frequency ω. ŝ=ŝ(r,ω) is the source vector. The matrices Â and \hat{B} describe spatially-varying medium parameters. The operator \hat{D}ᵣ contains the spatial differential operators ∂_{1,2,3}. The term, (iω+v·∇) contains a time derivative (i.e. the Fourier dual of iω) in the medium's reference frame, and v which is the spatially-varying velocity of the moving medium.

Theorems for dynamic systems satisfying the linear partial differential equation above include,

∫ᵥ[û_{A}^{T}Kŝ_{B}−ŝ_{A}^{T}Kû_{B}]d³r= [symbol] û_{A}^{T}\hat{M}₁û_{B}d²r+∫ᵥû_{A}^{T}\hat{M}₂û_{B}d³r (1)

with \hat{M}₁=K[Nᵣ−Â_{A}(v_{A}·n)] and

\hat{M}₂=K[Â_{B}(iω+v_{B}·∇)−Â_{A}(iω−v_{A}·∇)]+K[\hat{B}_{B}−\hat{B}_{A}]; and ∫ᵥ[û_{A}^{†}ŝ_{B}+ŝ_{A}⁵⁵⁴ û_{B}]d³r= [symbol] û_{A}^{†}\hat{M}₃û_{B}d²r+∫ᵥû_{A}^{†}\hat{M}₄û_{B}d³r, (2)

where \hat{M}₃Nᵣ−Â_{A}^{†}(v_{A}·n), and \hat{M}₄=Â_{B}(iω+v_{B}·∇)−Â_{A}^{†}(iω+v_{A}·∇)+\hat{B}_{B}+\hat{B}_{A}^{†}. The subscripts A and B pertain to two wave states, to which we shall refer respectively as State A and State B. The matrix K is a real-valued diagonal matrix K=K⁻¹ such that KAK=A^{T}, KBK=B^{T} and KDᵣK=−Dᵣ^{T}. The superscript T denotes the transpose, while † represents the adjoint (i.e., the conjugate-transpose matrix). n is the outward-pointing normal at ∂v. The operator Nᵣ is defined analogously to Dᵣ but instead it contains the nᵢ elements of the vector n.

Equation 1 is a convolution-type reciprocity theorem while equation 2 is a correlation-type theorem. When the field response is described by Green's tensors (see below), equation 1 results in a generalized source-receiver reciprocity theorem when Â_{A}=Â_{B}, \hat{B}_{A}=\hat{B}_{B} and v_{A}=−v_{B}. In special cases for the material properties, the correlation-type theorem in equation 2 leads to a general form of Green's function retrieval by cross-correlations (i.e., a general form of interferometry).

Equations 1 and 2 may be rewritten for the special case of perturbed media. Physical phenomena in perturbed media can be described by the set of equations

Â(iω+v·∇)û+\hat{B}û+\hat{D}ᵣû=ŝÂ₀(iω+v₀·∇)û₀+\hat{B}₀û₀+\hat{D}ᵣû₀=ŝ (3)

where the subscript 0 denotes unperturbed field quantities and medium parameters, whereas its absence indicates field quantities and medium parameters that are perturbed. Every perturbed quantity or parameter can be written as a superposition of its unperturbed counterpart and a perturbation. Thus, Â=Â₀+Â_{S}, \hat{B}=\hat{B}₀+\hat{B}_{S}, v=v₀+v_{S} and û=û₀+û_{S}, where the subscript S represents a perturbation. Note that to treat perturbed media, the source vector ŝ is the same for both the unperturbed and perturbed cases (equation 3). Subtracting the second in equation 3 from the first one yields the identity

\hat{V}û₀=\hat{L}û_{S}; (4)

where \hat{L} is the linear differential operator in the first line of equation 3, and \hat{V} is a perturbation operator given by {circumflex over ( V̅=Â(iω+v·∇)−{circumflex over (Ā₀(iω+v₀·∇) +̅\hat{B}−\hat{B}₀. This operator is also referred to as the scattering potential in quantum mechanics. The identity in equation 4 shows that the field perturbations û_{S}⁻ do not satisfy the same field equations as the ones satisfied by field quantities û and û₀ (equation 3). The form of equation 4 allows for an expansion of û_{S} in terms of \hat{V}û₀. This series expansion can be done in different ways, e.g., according to the Lippmann-Schwinger series or to the Bremmer coupling series. The perturbation approach and these types of series expansions are useful in describing scattering phenomena.

A convolution-type representation theorem may be derived from equation 1 for general perturbed media. Throughout this paper, the discussion is centered on theorems that relate unperturbed fields in State A with perturbed fields in State B. In this perturbation approach we set Â_{A}=Â_{B}=Â, Â_{A,0}=Â_{B,0}=Â₀, \hat{B}_{A}=\hat{B}_{B}=\hat{B}, \hat{B}_{A,0}=\hat{B}_{B,0}=\hat{B}₀, and likewise for v and v₀. Thus, from equation 1 we start with

∫ᵥ[û_{A,0}^{T}Kŝ_{b}−ŝ_{A}^{T}Kû_{B}]d³r= [symbol] û_{A,0}^{T}\hat{M}₁^{P}û_{B}d²r+∫ᵥû_{A,0}^{T}\hat{M}₂^{P}û_{B}d³r; (5)

where \hat{M}₁^{P}=K[Nᵣ−Â₀(v₀·n)] and \hat{M}₂^{P}=K[Â(iω+v·∇)−Â₀(iω−v₀·∇)+\hat{B}−\hat{B}₀].

∫ᵥ[û_{A,0}^{T}Kŝ_{B}−ŝ_{A}^{T}Kû_{B,0}]d³r= [symbol] û_{A,0}^{T}\hat{M}₁⁰û_{B,0}d²r+∫ᵥû_{A,0}^{T}\hat{M}₂⁰û_{B,0}d³r, (6)

with \hat{M}₁⁰=\hat{M}₁^{P}=K[Nᵣ−Â₀(v₀·n)] and \hat{M}₂⁰=K[2Â₀(v₀·∇)]. By using the identity û=û₀+û_{S}, and after inserting equation 6 in the left-hand side of equation 5 we get

−∫ᵥŝ_{A}^{T}Kû_{B,S}d³r= [symbol] û_{A,0}^{T}\hat{M}₁^{P}û_{B,S}d²r+∫ᵥû_{A,0}^{T}\hat{M}₂^{P}û_{B,S}d³r+∫ᵥû_{a,0}^{T}K\hat{V}û_{B,0}d³r (7)

given that Δ\hat{M}₂=\hat{M}₂^{P}−\hat{M}₂⁰=K\hat{V}. This equation is a generalized convolution-type theorem that relates field perturbations at State B (left-hand side of the equation), with field perturbations and unperturbed fields in both States in the right-hand side.

The following step is to convert the reciprocity theorem in equation 7 into a representation theorem by replacing the field quantities by their corresponding Green's functions. The Green's matrices satisfy \hat{L}Ĝ=1δ(r′−r) and \hat{L}₀Ĝ₀=1δ(r′−r), with Ĝ⁻=Ĝ₀+Ĝ_{S}. In this formulation waves in State A are described by Ĝ₀(r_{A}, r), denoting the Green's matrix for the unperturbed impulse response observed at r_{A} due to an excitation at r (for brevity we omit the dependency on the frequency ω). Likewise waves in State B are represented by the perturbed Green's matrix Ĝ(r_{B}, r). This gives

K′Ĝ_{S}(r_{B},r_{A})= [symbol] Ĝ₀^{T}(r_{A},r)\hat{M}₁^{P}Ĝ_{S}(r_{B},r)d²r+∫ᵥĜ₀^{T}(r_{A},r)\hat{M}₂^{P}Ĝ_{B}^{S}(r_{B},r)d³r. +∫ᵥĜ₀^{T}(r_{A},r)K\hat{V}Ĝ_{B}⁰(r_{B},r)d³r, (8)

where K′=−K. Equation 8 is important for the description of field perturbations for many physical systems. To illustrate this, let us consider a special case: that of fields in nonmoving media (i.e., v=v₀=0), or when v=−v₀. In either case, equation 8 simplifies to

K′Ĝ_{S}(r_{B},r_{A})= [symbol] Ĝ₀^{T}(r_{A},r)\hat{M}₁^{P}Ĝ_{S}(r_{B},r)d²r+∫ᵥĜ₀^{T}(r_{A},r)K\hat{V}Ĝ_{B}(r_{B},r)d³r. (9)

Equation 9 is a generalized version of Green's Theorem as it is usually presented in the physical description of many different physical phenomena. It shows that the Green's matrix for the field perturbations observed r_{B} can be reconstructed by convolutions of unperturbed fields observed at r_{A} with unperturbed fields and field perturbations observed at r_{B}. The boundary integral vanishes when i) homogeneous boundary conditions are imposed on ∂v or ii) when the boundary tends to infinity and one or more of the loss matrices \hat{B}, \hat{B}₀, Jm{Â} or Jm{Â₀} are finite within the support of v (i.e., when fields are quiescent at infinity). In either case, equation 9 gives

K′Ĝ_{S}(r_{B},r_{A})=∫ᵥĜ₀^{T}(r_{A},r)K\hat{V}Ĝ(r_{B}, r)d³r. (10)

This equation is a general matrix-vector form of the Lippmann-Schwinger integral, yielding field perturbations for any physical phenomena described by equation 3. Along with series expansions for field perturbations that follow from equation 4, equations 8 and 10 describe scattering phenomena.

Correlation-type representation theorems may be derived for perturbed media, based on the more general theorems. We begin, in analogy to the previous derivation, by rewriting equation 2 to relate unperturbed fields in State A with perturbed fields in State B, with the following expression

∫ᵥ[û_{A,0}^{†}ŝ_{B}+ŝ_{A}^{†}û_{B}]d³r= [symbol] û_{A,0}^{†}\hat{M}₃^{P}û_{B}d²r+∫ᵥû_{A,0}^{†}\hat{M}₄^{P}û_{B}d³r; (11)

where the matrices \hat{M}₃^{P} and \hat{M}₄^{P} are given by \hat{M}₃^{P}=Nᵣ−Â₀^{†}(v₀·n) and \hat{M}₄^{P}=Â(iω+v·∇)−Â₀^{†}(iω+v₀·∇ )̅+\hat{B}+\hat{B}₀^{†} . Also analogously to the derivation in the previous section, we consider a correlation-type theorems relating unperturbed fields in both States from equation 1, given by

∫ᵥ[û_{A,0}^{†}ŝ_{B}+ŝ_{A}^{†}û_{B,0}]d³r= [symbol] û_{A,0}^{†}\hat{M}₃⁰û_{B,0}d²r+∫ᵥû_{A,0}^{†}\hat{M}₄⁰û_{B,0}d³r, (12)

with \hat{M}₃⁰=\hat{M}₃^{P}=Nᵣ−Â₀^{†}(v₀·n) and \hat{M}₄⁰=Â₀(iω+v·∇)−Â₀^{†}(iω+v₀·∇)+\hat{B}₀+\hat{B}₀^{†}. Given that \hat{M}₄^{P}−\hat{M}₄⁰=\hat{V}⁻ and û=û₀+û̂ₛ, then by inserting equation 12 in the left-hand side of equation 11 gives

∫ᵥŝ_{A}^{†}û_{B,S}d³r= [symbol] û_{A,0}^{†}\hat{M}₃^{P}û_{B,s}d²r+∫ᵥû_{A,0}^{†}\hat{M}₄^{P}û_{B,S}d³r+∫ᵥû_{A,0}^{†}\hat{V}û_{B,0}d³r (13)

This is a generalized correlation-type theorem that relates field perturbations at State B (left-hand side of the equation) unperturbed and perturbed fields on both States (right-hand side). Note that, as in the convolution theorem in equation 7, the surface integral contains unperturbed fields from State A and field perturbations from State B. With the same Green's matrix representation used in deriving equation 9, equation 13 can be written as

Ĝ_{S}(r_{B},r_{A})= [symbol] Ĝ₀^{†}(r_{A},r)\hat{M}₃^{P}Ĝ_{S}(r_{B},r)d²r+∫ᵥĜ₀^{†}(r_{A},r)\hat{M}₄^{P}Ĝ_{S}(r_{B},r)d³r+∫ᵥĜ₀⁵⁵⁴ (r_{A},r)\hat{V}\hat{G}₀(r_{B}, r)d³r. (14)

This correlation-type representation theorem describes how the field perturbations sensed at r_{B} due to a source at r_{A} can be retrieved from cross correlations between unperturbed fields sensed at r_{A} with unperturbed fields and field perturbations observed at r_{B}. Equation 14 relates to the general formulations proposed by Wapenaar et al. (2006) and Snieder et al. (2007). In the formulation by Wapenaar et al. and Snieder et al., the reconstruction of the Green's functions by cross-correlations retrieves the causal and anticausal unperturbed responses Ĝ₀(r_{B},r_{A}) or Ĝ₀^{†}(r_{B},r_{A}), or the perturbed ones Ĝ(r_{B},r_{A}). or Ĝ^{†}(r_{B},r_{A}). Here, the theorem in equation 14 (as well as in equation 9) retrieves only the causal field perturbation matrix Ĝ_{S}(r_{B},r_{A}). Because the theorems of Wapenaar et al. and Snieder et al. retrieve both causal and anticausal responses, we refer to them herein as two-sided theorems; while equation 14 is a one-sided theorem because it only yields a causal response. In general, the volume integrals in equation 14 cannot be neglected, so the response Ĝ_{S}(r_{B},r_{A}) cannot typically be extracted only from the surface integral.

Reconstructing the Scattered Field Response

Monitoring parameter changes from volume sources. Although in general the correlation theorem in equation 14 is not suitable for the practice of “remote sensing without a source”, there are two important special cases that do allow for the retrieval of the medium's response from observed fields. Let us consider first the case of a nonmoving medium (v=v₀=0) when the boundary integral in equation 14 vanishes (see necessary conditions in the derivation of equation 10). In that case, and given that \hat{M}₄^{P}=\hat{M}₄0+\hat{V}, equation 14 becomes

Ĝ_{S}(r_{B},r_{A})=∫ᵥĜ₀^{†}(r_{A},r)\hat{M}₄⁰Ĝ_{S}(r_{B},r)d²r+∫ᵥĜ₀^{†}(r_{A},r)\hat{V}Ĝ(r_{B},r)d³r. (15)

Now since \hat{M}₄⁰=Jm{Â)}+\hat{B}₀+\hat{B}₀^{\}, the first integral in equation 15 accounts only for energy dissipation in the background medium. Hence, when the background loss parameters (represented by the matrix \hat{M}₄⁰ are negligible compared to the changes \hat{V}, the first integral in equation 15 can be ignored leaving

Ĝ_{S}(r_{B},r_{A})=∫ᵥĜ₀^{†}(r_{A},r)\hat{V}Ĝ(r_{B},r)d³r. (16)

Note that this integral is remarkably similar to the generalized Lippmann-Schwinger integral in equation 10, with Ĝ₀(r_{A},r) replaced by ⁻Ĝ₀^{†}(r_{A},r)⁻ in the integrand. We shall explore this similarity later in our discussion. Next, we consider volume noise sources \hat{σ}(r,ω) distributed within V. For any two such noise sources, their respective vector elements \hat{σ}ᵢ(r,ω) and \hat{σ}ⱼ(r′,ω′) are uncorrelated for any i≠j and r≠r′; while their power spectrum is the same for any r and source-vector components, apart from frequency- and space-varying excitation functions. The uncorrelated noise sources obey the relation [symbol] \hat{σ}(r)\hat{σ}^{†}(r′) [symbol] =||\hat{N}||²\hat{Σ}\hat{V}(r)δ(r−r′), where the right-hand side is a spatial ensemble average, ||\hat{N}||² is the noise power spectrum and the diagonal matrix \hat{Σ} contains the excitation functions. The presence of \hat{V} in the ensemble average above indicates that the perturbed-state volume sourcest \hat{σ}(r,ω) are locally proportional to the medium parameter changes at r. Under these conditions, the spatial averaging of the measured responses û^{obs}(r) is

(û^{obs}(r_{B}){û₀^{obs}(r_{A})}^{†})=∫ᵥ||\hat{N}||²Ĝ₀^{†}(r_{A},r)\hat{Σ}\hat{V}Ĝ(r_{B},r)d³r. (17)

Using this result together with that in equation 16 gives

Ĝ_{S}(r_{B},r_{A})\hat{N}=(û^{obs}(r_{B}){û₀^{obs}(r_{A})}^{†}). (18)

For cases where equation 16 is valid, equation 18 states that one can obtain the scattered field response between the observation points at r_{A} and r_{B} by cross correlations of ambient noise records used in evaluating (û^{obs}(r_{B}){û₀^{obs}(r_{A})}^{†}). What sets this result apart from previous results for generalized representation theorems is that here the random volume noise sources are locally proportional to the medium parameter perturbation, e.g., observed signals can be thought of as being caused by changes in the medium. This interpretation of the general result in equation 18 is closely connected with the concept of coda-wave interferometry. Coda-wave theory relies on a energy propagation regime where the volume scatterers (i.e., the medium perturbations here described by the spatially-varying matrix \hat{V}) behave as secondary sources emitting waves that sample and average the medium multiple times. In the practice of coda-wave interferometry, cross-correlations of the late portions of the observed data (which represent waves in the multiple scattering regime) provide a measure of the medium perturbations and can be used to monitor changes in the medium. The result in equation 18 is related to that of coda-wave interferometry because the excitation is provided by volume sources that are proportional to the medium perturbation (i.e., to the local scattering strength), and the cross-correlations of the data observed at the two observation points yields an estimate of the scattered field impulse response between the two receivers. While coda-wave interferometry is typically accomplished by single receiver measurements (where r_{A}=r_{B}), equation 18 demonstrates that the cross-correlations of the responses sensed at two or more receivers can also extract information about scatterers and/or changes in the medium. Furthermore, the result in equation 18 applies not just to waves in lossless materials (e.g., acoustic and elastic); it also holds for dissipative acoustic, elastic and electromagnetic phenomena, quantum-mechanical waves, mass, heat or advective transport systems, etc. Therefore, the concept of monitoring medium perturbations introduced by coda-wave interferometry in fact applies to experiments with multiple observation points and all physical systems where equation 16 holds.

Reconstructing Perturbations from the Surface Integral

Another important special case for equation 14 occurs in the context of retrieving the Green's matrix of field perturbations by cross-correlations. Setting the loss matrices. \hat{B}=\hat{B}₀⁻=Jm{Â₀}=Jm{Â₀}= 0̅, equation 14 yields

Ĝ_{S}(r_{B},r_{A})= [symbol] Ĝ₀^{†}(r_{A},r)\hat{N}ᵣĜ_{S}(r_{B},r)d²r+∫ᵥĜ₀^{†}(r_{A},r)\hat{V}Ĝ(r_{B},r)d³r; (19)

where \hat{M}₄^{P}=\hat{V}. Since equation 19 holds when all loss matrices are set to zero, it is strictly valid for systems that are invariant under time-reversal. Thus, equation 19 retrieves the field perturbations Ĝ_{S}⁻(r_{B},r_{A}) for lossless acoustic and elastic wave propagation, for electromagnetic phenomena in highly resistive media, and for the Schrödinger equation, for example. Next, we consider a medium configuration as in FIG. 2, where \hat{V}≠0 only for r ε̅sup [symbol] and the observation points are away from [symbol] . In this configuration, there are sources r₁ ε̅∂V₁ (where ∂V₁ is a continuous segment of ∂V) for which the stationary paths of the direct-trasmitted unperturbed waves are not affected by the medium perturbations in [symbol] . This is depicted in FIG. 2a. Because the unperturbed waves do not cross [symbol] , the leading order stationary phase contribution of Ĝ₀^{†}(r_{A},r){circumflex over ( V̅Ĝ₀(r_{B},r) to the volume integral in equation 19 is negligible because \hat{V}=0 along the stationary unperturbed-wave paths.

While the remaining contribution of the volume integral (given by Ĝ₀^{†}(r_{Z},r)\hat{V}Ĝ_{S}(r_{b},r) in the integrand) is not negligible, its contribution (to leading order in the scattered fields) has the same phase of that of the surface integral since the integrands also have the same phase. Therefore, it is possible to estimate the scattered field response according to

Ĝ_{S}(r_{B},r_{A})≈∫_{∂V}_{₁}Ĝ₀^{†}(r_{A},r)\hat{N}ᵣĜ_{S}(r_{B},r)d²r. (20)

Evaluating solely the surface integral according to equation 20 should then retrieve Ĝ_{S}(r_{B},r_{A}) with correct phase spectra, but the amplitude spectra might be distorted by ignoring the volume integral in equation 19. Note also that the result in equation 20 is not valid for all sources in the closed surface ∂V. When ∂V₁ is an infinite plane, and the wave propagation regimes can be described by coupled one-way operators, the result in equation 20 is exact: the out-going scattered waves propagating between receivers are obtained by cross-correlations of the scattered fields observed at ∂V₁ with the measured in-going transmitted waves. The result in equation 20 can be used to retrieve Ĝ_{S}(r_{B},r_{A}) from remote sources on ∂V₁. Here the terms out- and in-going waves to denote propagation direction with respect to the position of target scatterers; i.e., in-going waves propagate toward the scatterers, whereas back-scattered waves are out-going.

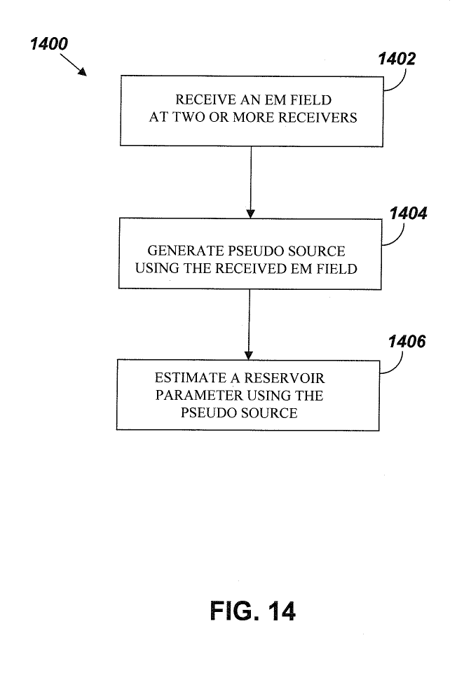

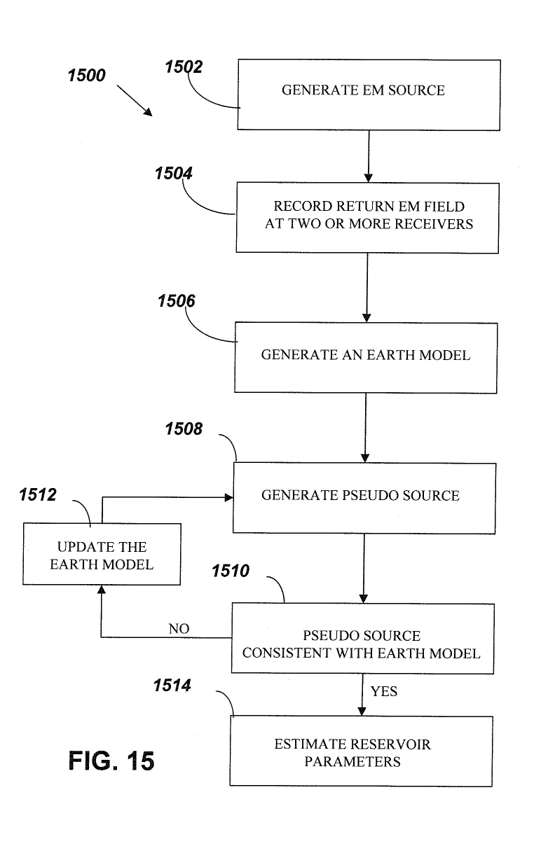

Referring now to FIGS. 14 and 15 and with the benefit of the above-described geophysical information gathering system 100 and interferometry techniques, methods for gathering geophysical information will be described. Referring to FIG. 14, a method 1400 according to one or more embodiments includes 1402 receiving an electromagnetic field at two or more receivers, 1404 generating a pseudo-source using the received electromagnetic fields, and 1406 estimating a reservoir parameter using the pseudo-source. The term pseduo-source as used herein refers to a suite of geophysical information generated from return information received at a plurality of receivers, where the generated information represents a physical source of known characteristics located at a receiver location. The received electromagnetic field may be the result of a physical source field interacting with a subsurface target, or the received field may be the result of natural electromagnetic radiation, such as from the sun, penetrating the earth and interacting with the subsurface target.

FIG. 15 illustrates an iterative method 1500 that includes 1502 generating an electromagnetic source field and 1504 recording a return electromagnetic field at two or more receivers. The method 1500 further includes 1506 generating an Earth model, 1508 generating a pseudo-source, and 1510 determining whether the Earth model and pseudo-source are consistent. In this method, the Earth model consists of one- or multi-dimensional representations of the subsurface structure. In one embodiment, the representations may be two- or three-dimensional representations, in any form, of any quantitative or qualitative forms of spatial parameter distributions of relevant physical properties of the subsurface materials. Relevant physical properties of the subsurface materials may include, for example: acoustic, elastodynamic, electric, electromagnetic, seismo-electric, thermal, or mass properties. Where there is consistency between the pseudo-source and the Earth model 1510, reservoir parameters may be estimated 1514, otherwise 1512 the Earth model is updated and a new pseudo-source is generated 1508. A final Earth model can be obtained via the method described in regard to FIG. 15 by setting chosen quantitative thresholds for measuring consistency between the acquired data and the data predicted based on the current Earth model. Additionally, the inference of a final Earth model through an iterative method may also draw upon any other types of additional subsurface information, e.g., seismic data and/or images, borehole geophysical information, or any other type of geophysical data.

While a single pseudo-source record for a given radiator location can be generated from a minimum of two receivers, it is also possible to generate pseudo-source data from all possible receiver combinations from a plurality of receivers distributed over a chosen survey area. Increasing the number of receivers for which pseudo-source data is generated increases the overall volume of pseudo-source data and can provide additional information about the target subsurface structures and their physical properties.

The methods as described above may be conducted whether or not physical source parameters are known. Electromagnetic interferometry techniques according to one or more embodiments may include using interferometry to process information in the form of data signals generated by poorly known and/or controlled physical sources to generate pseudo-sources at the receiver locations, where the pseduo-sources have precisely-known parameters. The pseudo-sources can then be used to extract more complete and reliable information about the Earth's subsurface. Several embodiments may use aspects of the general theory discussed above to obtain the desired results from interferometry. We shall consider two examples, which lead to two different data processing routines.

### EXAMPLE 1

In this example, sources and receivers may be densely sampled, and both the vertical electric and magnetic fields are reliably measured. The method includes using electric and magnetic fields recorded at receivers x_{A} and x to separate the upward decaying fields in \hat{P}⁻(x_{A},x_{S}) from the downward decaying fields in \hat{P}⁺(x,x_{S}). Where \hat{P}⁻ and \hat{P}⁺ are flux-normalized up-going and down-going vector fields, respectively. The method further includes solving the inverse integral equation for \hat{R}₀⁺(x_{A},x), where \hat{R}₀⁺ is the Fourier transform of an impulse response, from the input data \hat{P}⁻(x_{A},x_{S}) and \hat{P}⁺(x,x_{S}). Then, we may use \hat{R}₀⁺(x_{A},x) (which is the pseudo-source response) to estimate subsurface information.

### EXAMPLE 2

In this example, the receivers are coarsely sampled, and/or the separation of up- from down-decaying fields is not feasible, i.e., vertical fields cannot be measured or data are unreliable. A method suitable for these conditions includes establishing a prior background model describing electromagnetic properties of sea water and air, or use a best-fit subsurface model from standard processing of CSEM data. The method further includes numerically modeling fields Ĝ₀(r_{A},r) and Ĝ₀(r_{B},r) to simulate background response acquired by receivers at r_{A} and r_{B}. The method includes matching Ĝ₀(r_{A,B},r) to the full-field acquired data û(r_{A,B},r) by adaptive subtraction and obtain û₀(r_{A,B},r) and û_{S}(r_{A,B},r) as by-product.

One may then evaluate equation 14 above to estimate pseudo-source response Ĝ_{S}(r_{B},r_{A}). The surface integral is computed from the data û₀(r_{A,B},r) and û_{S}(r_{A,B},r). The Green's function kernel can be computed via matrix-vector field deconvolutions. The volume integrals are evaluated numerically by setting the zero-order scattering approximation Ĝ_{S}→Ĝ₀; the matrix \hat{M}₄⁰ is computed from the background model, and \hat{V} is extracted fom a prior Earth model, which may come from standard CSEM processing, or from previous iterations of this processing routine.

In one or more embodiments, one may then use the estimated pseudo-source response Ĝ_{S}(r_{B},r_{A}) to infer or estimate subsurface properties. Where the estimated Earth model properties are not consistent with the originally acquired data, one may then iterate the above evaluation to estimate Ĝ_{S}(r_{B},r_{A}) and estimate the subsurface properties until reaching an acceptable Earth model that is within a predetermined threshold. An “acceptable” Earth model can be defined by some form of qualitative and/or quantitative measure of the differences between the acquired data and the data that would be predicted based on the current Earth model. In addition, the criteria for acceptable Earth models may also rely on other geophysical or geological information, e.g., maps, borehole data, seismic profiles, seismic images, gravity data, or resistivity profiles.

The methods of the present disclosure may be performed using electromagnetic information or in combination with any other useful geophysical information. For example, estimating parameters 406, 1514 may include the use of seismic information gathered before, concurrently with or after gathering the electromagnetic information. In one or more embodiments, other geophysical information such as seismic information may be used to generate, constrain, or otherwise clarify the Earth model 1506.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Such insubstantial variations are to be considered within the scope of the claims below.

Given the above disclosure of general concepts and specific embodiments, the scope of protection is defined by the claims appended hereto. The issued claims are not to be taken as limiting Applicant's right to claim disclosed, but not yet literally claimed subject matter by way of one or more further applications including those filed pursuant to the laws of the United States and/or international treaty.

What is claimed is:

1. A method for gathering geophysical information comprising:
receiving electromagnetic energy emanating from a target using a plurality of receivers; and
generating a pseudo-source based at least in part on a location of one or more of the plurality of receivers and the received electromagnetic energy.

2. A method according to claim 1, wherein the act of receiving electromagnetic energy comprises receiving multi-component electromagnetic energy.

3. A method according to claim 2, wherein the multi-component electromagnetic energy comprises: one or more magnetic components, one or more electrical components, or a combination thereof.

4. A method according to claim 1, wherein the plurality of receivers comprises: one or more receivers located on land, in a marine environment, or in an area that includes both a land portion and a marine portion.

5. A method according to claim 1, wherein the act of generating a pseudo-source further comprises using a computer-generated set of parameters.

6. A method according to claim 5, wherein the generated set of parameters emulate a physical source having known parameters, and wherein the emulated physical source is located at or near the location of one of the receivers.

7. A method according to claim 1 further comprising the act of:
transmitting electromagnetic energy from a physical source, wherein the electromagnetic energy emanating from the target is responsive to the transmitted electromagnetic energy.

8. A method according to claim 7, wherein the physical source comprises a multi-dimensional structure that generates multi-component electromagnetic energy fields.

9. A method according to claim 8, wherein the act of transmitting the electromagnetic energy further comprises transmitting a multi-component electromagnetic energy field.

10. A method according to claim 1, further comprising the act of:
generating an initial Earth model.

11. A method according to claim 10, further comprising the act of:
updating the Earth model based at least in part on the generated pseudo-source.

12. A method according to claim 8, further comprising the act of:
conveying the physical source,
wherein the conveying comprises conveying the physical source in a body of water, on land, in the air, underground, or any combination thereof.

13. A method according to claim 7, wherein the act of generating a pseudo-source further comprises generating a set of parameters that are independent of any parameter of the physical source.

14. A method according to claim 1, wherein the act of generating a pseudo-source further comprises generating pseudo-source parameters for each receiver in the plurality of receivers.

15. A system for gathering geophysical information comprising:
a processor;
a physical source configured to transmit electromagnetic energy; and
a plurality of receivers configured to receive electromagnetic energy emanating from a target;
wherein the processor generates a pseudo-source based at least in part on a location of one or more of the plurality of receivers and the received electromagnetic energy.

16. A system according to claim 15, wherein the plurality of receivers are further configured to receive multi-component electromagnetic energy.

17. A system according to claim 16, wherein the multi-component electromagnetic energy includes one or more magnetic components, one or more electrical components, or a combination thereof.

18. A system according to claim 15, wherein the plurality of receivers includes one or more receivers located on land, in a marine environment, or in an area that includes both a land portion and a marine portion.

19. A system according to claim 15, wherein the processor is further configured to generate a set of parameters representative of the pseudo-source.

20. A system according to claim 19, wherein the generated set of parameters emulate a physical source having known parameters, and wherein the emulated physical source is located at or near the location of one of the receivers.

21. A system according to claim 15, wherein the electromagnetic energy emanating from the target is responsive to the transmitted electromagnetic energy.

22. A system according to claim 15, wherein the physical source comprises a multi-dimensional structure that generates multi-component electromagnetic energy fields.

23. A system according to claim 22, wherein the physical source is further configured to transmit a multi-component electromagnetic energy field.

24. A system according to claim 15, wherein the processor is further configured to generate an initial Earth model.

25. A system according to claim 24, wherein the processor is further configured to update the Earth model based at least in part on the generated pseudo-source.

26. A system according to claim 15, wherein the physical source is further configured to be conveyed in a body of water, on land, in the air, underground, or any combination thereof.

27. A system according to claim 15, wherein the processor is further configured to generate pseudo-source parameters that are independent of any parameter of the physical source.

28. A system according to claim 15, wherein the processor is further configured to generate pseudo-source parameters for each receiver in the plurality of receivers.

29. A computer usable medium having a computer readable program code embodied therein, wherein the computer readable program code is adapted to be executed to implement the method of claim 1.
